(19) United States
(12) Patent Application Publication
(10) Pub. No.: US 2009/0155328 A1
(43) Pub. Date: Jun. 18, 2009

(54) FILMS COMPRISING ANTIMICROBIAL AND FUNGISTATIC AGENTS

(75) Inventor: I-HWA LEE, Wilmington, DE (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(73) Assignee: E. I. DU PONT DE NEMOURS AND COMPANY, Wilmington, DE (US)

(21) Appl. No.: 12/330,101

(22) Filed: Dec. 8, 2008

Related U.S. Application Data
(60) Provisional application No. 61/013,969, filed on Dec. 14, 2007.

(51) Int. Cl. A01N 25/34; B05D 1/28; B32B 37/14

(52) U.S. Cl. 424/405; 427/256; 156/90

(57) ABSTRACT

A process for producing a film having incorporated or applied thereon or therein an antimicrobial agent and a liquid additive is provided wherein the film comprises a liquid absorbent layer and an impermeable layer are provided. The films can be used for producing a tubular casing or shrinkbag such as casings for foodstuffs.

This application claims the benefit of U.S. Provisional Application No. 61/013,969, filed Dec. 14, 2007, which is incorporated herein by reference in its entirety.

### FIELD OF THE INVENTION

This invention relates to a process for producing an antimicrobial film useful in packaging and/or for encasing foodstuffs.

### BACKGROUND OF THE INVENTION

Food safety of meat products has been a subject of increasing concern with several well-publicized outbreaks of contamination in fresh and ready-to-eat meats by food-borne pathogens in recent years. In a 1999 study, the US Center for Disease Control estimated that food borne diseases cause about 76 million illnesses, 325 thousand hospitalizations and 5000 deaths in the US annually. A 1999 FDA survey of the literature noted that the annual cost of food borne illnesses attributed to seven pathogens found in animal products runs to US $6.5 to 35 billion. Countries with reporting systems have documented significant increases during a period from 1975 to 1998 in the incidence of food borne disease attributed to contamination, survival of microorganisms and microbial growth.

In the case of processed ready-to-eat meat and poultry foods such as deli meats, sausages and hot dogs, re-contamination after cooking and other processing (curing, fermenting, drying, etc) may occur because of further handling, peeling, slicing and re-packaging. Of particular concern is the control of Listeria monocytogenes, a pathogen with high heat and salt tolerance and capable of thriving in refrigerated conditions. Other pathogens include Salmonella species, Escherichia coli, and Staphylococcus aureus.

The food industry has responded in various ways through irradiation, pasteurizations, high pressure processing, and use of antimicrobial agents. See, e.g., U.S. Pat. No. 6,451,365B1, U.S. Pat. No. 5,573,797, U.S. Pat. No.6,172,040B1, US Patent Application 2004/0043922A1 and US Patent Application 2003/0091612. Some of these disclosed methods incorporate an anti-microbial agent into foodstuffs or onto the surface of foodstuffs. Yet others incorporate anti-microbial agents into the packaging material or onto the packaging material. In general, blending of anti-microbial agents into the packaging material may be problematic. The anti-microbial agents may be rendered ineffective because of high processing temperatures used to process typical packaging films or structures. Sometimes the antimicrobial materials are costly and may be unnecessarily dispersed throughout the thickness of the packaging layer when activity of the antimicrobial agent need only occur on the surface of the layer in contact with food. The anti-microbial agents may also be immobilized within the polymer network of the film layer, making these agents less available to the surface. See, e.g., JP [1999]-158359 (a polyester elastomer composition where 0.1-20 parts by weight of an amino acid metal compound has been pre-coated onto the surface of inorganic particles); W02006000032A1 (an antimicrobial packaging material where 0.05 to 1.5 wt % of the material is a natural essential oil); and WO97/44387 (polyether copolymers where antimicrobial or fungistatic agents are melt blended in an amount of 0.05 to 20 wt %).

Similarly, the coating of antimicrobial compositions onto film is difficult to achieve effectively without a chemical treatment or corona treatment of the film surface. See, e.g., US Patent Application 2003/0091612 (attaching chitosan agents to a polyester surface that involves the process of treatment with basic solutions, washing the surface, subsequently re-treating with a strong mineral acid solution, re-washing the surface before exposure to the chitosan agents, and finally heating the treated surface); and US Patent Application 2004/0043922A1 (lactoferrin-containing agent is applied as a fine spray to form a film on the interior surface of casings). Cellulosic films can absorb up to 35 weight % water, a property useful for delivery of antimicrobial materials, since most of the antimicrobial systems of interest for foodstuffs use an aqueous medium for application. However, the films do not have adequate barrier properties and cannot be heat-sealed into food packages, thereby adding extra cost by removing foodstuff at some point to be placed into other plastic barrier packaging, which, while providing an oxygen or gas barrier, does not provide antimicrobial protection.

Also, manufacturing processes for fibrous and cellulose casings involve emissions of carbon disulfide and hydrogen sulfide to the atmosphere. This is regarded as unsustainable and damaging to the environment.

It is desirable to provide a process by which liquid additive may be applied to impermeable barrier casings with an absorptive inner layer comprising an antimicrobial or fungistatic agent.

### SUMMARY OF THE INVENTION

A process that can be used for coating or applying a fluid additive onto or into a flat film containing an absorptive polymer comprises, consists essentially of or consists of placing a fluid additive into a container having a moving gravure roll; picking up the additive from the container; delivering the additive into or onto the flat film containing an absorptive polymer wherein

the film comprises, consists essentially of, consists of, or is produced from a liquid absorptive inner layer and an outer impermeable barrier layer;

the inner layer comprises, or has contained therein or therewith a solution of, at least one antimicrobial or fungististatic agent; and

the barrier layer comprises, consists essentially of, consists of, or is produced from at least one polyamide, at least one polymer containing polyamide blocks and polyether blocks, at least one block copolyetherester elastomer, ethylene vinyl alcohol copolymer, polyvinylidene chloride, polyolefins, or combinations of two or more thereof.

The fluid additive optionally includes flavorant, colorant, or combinations thereof.

When the flat film is a shrink film, it may be laminated before, during, or subsequent to, the process.

### DETAILED DESCRIPTION OF THE INVENTION

Fluid additives suitable for use in the process of the invention can include liquids, semi-liquids, semi-gels, solutions, dispersions, emulsions, suspensions, or combinations of two or more thereof. An example of an additive is liquid smoke.

Examples of foodstuffs that can be processed and packaged include block cheeses, shredded cheeses, soft cheeses, breads, dry foods such as flours, beef, pork, poultry (e.g., chicken and turkey), seafood (e.g., fish and mollusks) and unpastuerized dairy products, or combinations of two or more thereof. Meat products include, but are not limited to, sausages, lunchmeats, hams, turkey logs or rolls, chicken logs or rolls, hot dogs, and kielbasa. Meat products can be whole-muscle, formulated into various meat slurries, formed into shapes, or ground. Formed or ground meat can optionally be a mixture of material derived from more than one animal species.

The fluid additive may be aqueous-based and may contain acids and/or bases. It can also be diluted with a solvent such as an alcohol, including ethanol, isopropyl alcohol, acetone, methyl ethyl ketone, or combinations of two or more thereof to facilitate drying or curing.

Fluid additive can be applied to the film, one layer of which is an absorptive layer as follows. The additive is placed in a container such as a trough or other container. A moving gravure roll is used to pick up the additive. The gravure roll can be embossed with cavities or pockets that are engraved to any desired form and depth. The gravure roll may also contain a cylinder comprising etched cells of specific dimensions to pick up and deliver the fluid additive. The etched cells may be quadrangular, tri-helical, pyramidal, channeled, or combinations of two or more of the shapes. The depth and number of cells can be chosen to accommodate the solids ratio of the liquid to be coated and the desired coating depth, which can be from about 0.0001 to about 1 inch, applied to the film.

The rolls can be engraved using any conventional, commercial engraving techniques such as, for example, acid etching process or engraving technique.

Backup rolls are generally used to contact coated films onto gravure rolls. Typically the backup rolls are made of silicone rubber of varying hardness as needed; and the backup roll width is generally sized to be about 5 to 15 mm less than the coating width desired. Nip roll pressures can be adjusted to provide adequate pressure in order to remove the liquid coating from the gravure roll to imprint onto the film. The gravure and backup rolls may be at any ambient temperature such as about 10 to about 50° C.

A scraper including knives, blades, or any scraping devices, such as a doctor blade, can be positioned against the rolls to provide even application, especially when a thin film coating of the additive is desired to be applied onto the surface of a casing. Appropriate pressure can also be applied by an impression roll, with or without a scraper, to the coating.

The application (i.e. coating) speed can be anywhere between about 5 to about 500 feet per minute (ft/min), or about 50 to about 350 ft/min. The coated additive can be cured by, e.g., drying in a heated forced air current in a drying tunnel. With heat curing, the temperature of the surface of the coated film can be from about 40° C. to about 150° C. or about 50° C. to about 1 20° C., depending on the nature of the additive.

The application can include a coating thickness of about 0.01 mil to about 2 mil or about 0.1 mil to about 1 mil (1 mil=25.4 μm). The coated film may be slit online to various widths before being taken up on wind up rolls.

In the practice of the invention, the film to be coated comprises a liquid absorptive inner layer and an outer impermeable barrier layer. The liquid absorptive inner layer is the layer that comes into direct contact with a foodstuff placed inside a casing. The outer impermeable barrier layer is the layer farthest from the foodstuff. The absorptive inner layer is useful for imparting flavor and color evenly to food such as meat during cooking.

The inner liquid absorptive layer can comprise or be produced from a polymer including block copolyetherester polymers, block copolyetheramide polymers, or combinations thereof. The outer layer can be and preferably is, an impermeable barrier layer. The inner layer and the outer layer can each be a single film layer, or a laminate or multilayer film comprising or produced from at least one polymer layer and optionally at least one tie layer.

The inner layer can have a moisture vapor transmission rate (MVTR) of at least about 1200 g·25 μ/m²·24 hrs, or from about 1200 to about 20000 g·25 μ/m²·24 hrs at 38° C., 100% humidity.

Polymers used in the liquid absorptive layer can be hydrophilic and hygroscopic. A copolyetherester is a thermoplastic polymer and can have a viscosity in the range of from about 20 pascal seconds (Pa·s) to about 3000 Pa s, about 40 to about 1000 Pa·s, or about 50 to about 700 Pa·s, as determined according to standard method ISO11443.

Copolyetheresters include one or more copolymers having a multiplicity of recurring long-chain ester units and short-chain ester units joined head-to-tail through ester linkages. The long-chain ester unit comprises repeat units of -OGO-C(O)RC(O)— and the short chain ester unit comprises repeat units of -OGO-C(O)RC(O)—. where G is a divalent radical remaining after the removal of terminal hydroxyl groups from poly(alkylene oxide)glycols having a number average molecular weight of between about 400 and about 6000, or preferably between about 400 and about 3000. R is a divalent radical remaining after removal of carboxyl groups from a dicarboxylic acid having a molecular weight of less than about 300. D is a divalent radical remaining after removal of hydroxyl groups from a diol having a molecular weight less than about 250.

The copolyetherester preferably contains about 15 to about 99 weight % short-chain ester units and about 1 to about 85 weight % long-chain ester units, or from about 25 to about 90 weight % short-chain ester units and about 10 to about 75 weight % long-chain ester units.

Suitable copolyetheresters are disclosed in US patents including U.S. Pat. No. 3,651,014, U.S. Pat. No. 3,766,146, and U.S. Pat. No. 3,763,109. Commercially available copolyetheresters include Hytrel® from E. I. du Pont de Nemours and Company (DuPont). Others include Arnitel® from DSM in the Netherlands and Riteflex® from Ticona, USA.

An example of a suitable copolyetherester is a polymer that comprises long chain ester units derived from an ethylene oxide/propylene oxide copolyether glycol having a molecular weight of about 1800 to about 2500 or about 2150.

The liquid absorptive layer in the film may also comprise block copolyetheramides. Such block copolyetheramides can comprise or consist of crystalline polyamide and noncrystalline polyether blocks. Polyamides may be, for example, nylon 6 or nylon 12.

Copolyetheramides are also well known in the art as disclosed in U.S. Pat. No. 4,331,786. They comprise a linear and regular chain of rigid polyamide segments and flexible polyether segments, as represented by the formula HO—[C(O)PAC(O)OPEO]ₙ—H where PA is a linear saturated aliphatic polyamide sequence formed from a lactam or amino acid having a hydrocarbon chain containing 4 to 14 carbon atoms or from an aliphatic C₆-C₉ carbon diamine, in the presence of a chain-limiting aliphatic carboxylic diacid having 4-20 carbon atoms. The polyamide has an average molecular weight of between 300 and 15,000. In the above formula, PE represents a polyoxyalkylene sequence formed from one or more linear or branched aliphatic polyoxyalkylene glycols or copolyethers derived therefrom, said polyoxyalkylene glycols having a molecular weight of less than or equal to 6000. The subscript n indicates a number of repeat units sufficient to provide a polyetheramide copolymer that has an intrinsic viscosity of from about 0.8 to about 2.05. Processes for preparation of polyetheramides are well known (see, e.g., U.S. Pat. No. 6,815,480. A commercially available series of polyetheramides are available under the tradename “Pebax®” from Atofina.

The invention also includes a tubular casing or shrinkbag or thermoformable pouch, or standup pouch or a pillow pouch comprising a film comprising or produced from the film disclosed above in which the liquid absorptive inner layer can impart antimicrobial agent evenly to foodstuffs such as meats and cheeses.

That is, the films, tubular casings, shrinkbags or standup pouches or a pillow pouches can be further treated by the adsorption of at least one antimicrobial agent in solution into the liquid absorptive inner layer of the casing. The antimicrobial or fungistatic material is subsequently transferred to the foodstuff by contact of the foodstuff with the film surface or the enclosed atmosphere that surrounds the foodstuff, for example during food processing such as heating, curing, smoking or cooking. The antimicrobial composition remains in contact with the foodstuff until the foodstuff is ready to be consumed, because the laminate films as disclosed herein can be used to package the foodstuff.

Suitable antimicrobial and fungistatic materials include combinations of bacterial polypetides (e.g., nisin, a polycyclic polypeptide) and hop extracts; combinations of a bactericidal compound and beta hops acid or beta hops acid derivative or both; combinations comprising natamycin, dialkyl dicarbonate and a sorbate preservative; combinations comprising calcium lactate and a sequestering agent (including, but not limited to citric acid, tartaric acid, maleic acid, oxalic acid, ascorbic acid, erythorbic acid, phosphoric acid, benzoic acid, sorbic acid, propionic acid, salts thereof and mixtures thereof); heat-treated lactic and/or glycolic acid; lantibiotics; lysozyme; pediocin; lacticin; activated lactoferrin; chitosan; and combinations of two or more thereof. Chitosan disclosed herein also includes salts or derivatives of the chitosan. Sodium acetate may also be added to augment the antimicrobial combinations. Lactoferrin can be immobilized on a naturally occurring substrate via the N-terminus region of the lactoferrin. The bactericidal compound is lantibiotic, pediocin, lacticin class bacteriocin, lytic enzyme, or combinations of two or more thereof.

These antimicrobial agents can be used to effectively control a wide range of microorganisms including those such as Listeria monocytogenes, Listeria innocua, Salmonella typhimurium and other Salmonella species, Bacillus cereus, B. thuringiensis, B. subtilis, Saccharomyces cerevisiae, S. cerevisiae var. paradoxes, S. carlsbergensis, Candida bodinii, Pseudomonas fluorescens, Clostridium sporogenes, Lactobacillus sake, Brochothrzx thermosphacta, Micrococcus luteus, Yersinia enterocolitica, Enterobacter aerogenes, Zygosaccharomyces bailii, A. nidulans, A. niger, A. oryzae, Penicillium chrysogenum, P. roquefortii, or combinations of two or more thereof.

Also disclosed herein is a process that can be used for processing a foodstuff where the film disclosed above can be contacted with a solution comprising at least one antimicrobial agent disclosed above. The solution can be a 100% aqueous solution or water that contains about 0.1 to about 95 weight or volume % of a solvent such as an alcohol to facilitate the dissolution of the agent. One suitable solvent is ethanol which is frequently used in foodstuff applications. Other solvents can include acetone, acetic acid, propionic acid, butyric acid, propanediol, or combinations of two or more thereof. The solution can comprise about 0.01 to about 50%, or about 0.1% to about 20%, or about 0.2 % to about 10%, or about 0.2 to about 8%, by weight of the antimicrobial agent. Contact of the solution of the antimicrobial agent and the film can be by soaking, impregnation, spraying, brushing, or any means known to one skilled in the art.

The thus-prepared antimicrobial film can be washed with water, a solvent, or a solution containing about 0.1 to about 50 weight % of a base or an acid such as a metal hydroxide or mineral acid or lower alkyl fatty acid. The washing step can be carried out at any ambient temperature or as high as 100° C. for about 1 minute to about 5 hours. The antimicrobial film, whether washed or not, can be formed into an article as disclosed above. The article can include a pouch, bag, carton, blister, box, a thermoformed film, a vacuum skin film, or other container. The article can be contacted with essentially any known foodstuff including perishable foodstuffs to produce a foodstuff containing antimicrobial agent. Such foodstuff can be optionally heated at an elevated temperature, e.g., at about 30 to about 250° C. for a period of about 1 minute to about 5 hours.

The outer impermeable barrier layer of the treated film can be a single film layer, a laminate or multilayer film. The barrier layer comprises or is produced from at least one polymer including polyamides, copolyetheramides, block copolyetherester elastomers, ethylene vinyl alcohol copolymers (EVOH), polyvinylidene chloride, polyolefins, or combinations of two or more thereof. The layer optionally comprises an adhesive layer, useful as a tie layer between any two non-compatible layers in a laminated outer barrier layer. Examples of multilayer barrier structures include, from outermost layer to innermost layer: polyethylene/tie layer/polyamide; polyethylene/tie layer/polyamide/tie layer/polyethylene; polypropylene/tie layer/polyamide/EVOH/polyamide; polyamide/tie layer/polyethylene; polyamide/tie layer/polyethylene/tie layer/polyamide; polyamide/tie layer/polyamide/EVOH/polyamide. Depending on the nature of the innermost layer of the impermeable structure, an additional inner tie layer can be interposed between the impermeable structure and the absorptive layer to provide a desirable level of adhesion to the absorptive layer.

The layer can provide effective barriers to moisture and oxygen as well as provide bulk mechanical properties suitable for processing and/or packaging the foodstuff, such as clarity, toughness and puncture-resistance. For smoking and/or cooking processes, shrink properties in this layer can be desirable.

Suitable polyamides for use in the barrier layer include aliphatic polyamides, amorphous polyamides, or combinations thereof. Aliphatic polyamides can refer to aliphatic polyamides, aliphatic copolyamides, and blends or mixtures of these such as polyamide 6, polyamide 6.66, blends and mixtures thereof. Polyamides 6.66 are commercially available under the tradenames “Ultramid C4” and “Ultramid C35” from BASF, or under the tradename “Ube5033FXD27” from Ube Industries Ltd. Polyamide 6 is commercially available under the tradename Nylon 4.12 from DuPont.

The aliphatic polyamide may have a viscosity ranging from about 140 to about 270 cubic centimeters per gram (cm³/g) measured according to IS0307 at 0.5% in 96% H₂SO₄.

The film may further comprise other polyamides such as those disclosed in U.S. Pat. Nos. 5,773,059; 5,408,000; 4,174,358; 3,393,210; 2,512,606; 2,312,966 and 2,241,322. The film may also comprise partially aromatic polyamides, which can comprise repeat units derived from —HN—(CH₂)ₘ—CO— or the combination of —HN—(CH₂)ₙ—CO—, —HN—(CH₂)ₙ—NH—, and —CO—(CH₂)ₙ—CO— wherein m and n are each independently from about 5 to about 11. When used together with a polyamide, partially aromatic polyamides can be present, based on the weight of the total polymer weight, in amounts of about 5 to about 50%. Such polyamides can include amorphous nylon resins 6-I/6-T commercially available under the tradename Selar® PA from DuPont or commercially available under the tradename Grivory® G 21 from EMS-Chemie AG.

Copolyetheramides and coplyetheresters are the same as those disclosed above.

EVOH having from about 20 to about 50 mole % ethylene can be suitable for use in the barrier layer. Suitable types include those sold under the tradename Evalca® from Kuraray or Noltex® from Nippon Goshei. Polyvinylidene chloride (PVDC) suitable for use can be obtained commercially from Dow Chemical under the tradename Saran®.

Polyvinylidene chloride (PVDC) is a well known polymer derived from vinylidene chloride. PVDC has a very low permeability to moisture and other gases and is resistant to chemicals and solvents. It is available commercially from Dow Chemical and is suitable for use in the barrier layer of the treated films of the invention.

Polyolefins that may be used in the barrier layer include polypropylenes, polyethylene homopolymers and copolymers. Polyethylenes can be prepared by a variety of methods, including well-known Ziegler-Natta catalyst polymerization (see e.g., U.S. Pat. Nos. 4,076,698 and 3,645,992), metallocene catalyst polymerization (see e.g., U.S. Pat. Nos. 5,198,401 and 5,405,922) and by free radical polymerization. Polyethylenes can include linear polyethylenes such as high density polyethylene (HDPE), linear low density polyethylene (LLDPE), very low or ultralow density polyethylenes (VLDPE or ULDPE) and branched polyethylenes such as low density polyethylene (LDPE). The densities of polyethylenes suitable for use in the present invention range from 0.865 g/cc to 0.970 g/cc. Linear polyethylenes can incorporate α-olefin comonomers such as butene, hexene or octene to decrease density within the density range. The impermeable layer can comprise ethylene copolymers such as ethylene vinyl esters, ethylene alkyl acrylates, ethylene acid dipolymers, ethylene acid terpolymers and their ionomers. Examples of such ethylene copolymers are ethylene vinyl acetate, ethylene methyl acrylate and ethylene (meth)acrylic acid polymers and their ionomers. Polypropylene polymers useful in the practice of the present invention include propylene homopolymers, impact modified polypropylene and copolymers of propylene and alpha-olefins and their blends.

The adhesive layer (tie layer) can comprise anhydride-modified ethylene homopolymers, anhydride-modified ethylene copolymers, and/or any others known to one skilled in the art.

Anhydride or acid-modified ethylene and propylene homo- and co-polymers can be used as an extrudable adhesive layer or layers to improve bonding of layers of polymers together when the polymers do not adhere well to each other, thus improving the layer-to-layer adhesion in a multilayer structure. The compositions of the tie layers can be determined according to the compositions of the adjoining layers that are to be bonded in a multilayer structure. One skilled in the polymer art can select the appropriate tie layer based on the other materials used in the structure. Various tie layer compositions are commercially available under the trademark Bynel® from DuPont.

Impermeable films can additionally comprise one or more additives used in polymer films including plasticizers, stabilizers, antioxidants, ultraviolet ray absorbers, hydrolytic stabilizers, anti-static agents, dyes or pigments, fillers, fire-retardants, lubricants, reinforcing agents such as glass fibers and flakes, processing aids, antiblock agents, release agents, and/or mixtures thereof.

The particular polymer used can be converted into a film by various techniques. For example, a laminate film can be obtained by coextrusion as follows: granulates of the various components can be melted in extruders; the molten polymers passed through a die or set of dies to form layers of molten polymers that are then processed as a laminar flow. The molten polymers can be cooled to form a layered structure. Other suitable techniques include blown film extrusion, cast film extrusion, cast sheet extrusion and extrusion coating. The impermeable barrier film disclosed herein can be a coextruded tubular film obtained by a blown film extrusion process. The impermeable barrier film can be a coextruded flat film made by a cast film process. Both tubular and flat films may be further slit to obtain flat films of desired widths. The coextruded films can be further oriented beyond the immediate quenching or casting of the film. The process can comprise coextruding a multilayer laminar flow of molten polymers, quenching the coextrudate and orienting the well-quenched coextrudate in at least one direction. “Well-quenched” means an extrudate that has been substantially cooled below its melting point in order to obtain a solid film.

The film may be uniaxially oriented, or biaxially oriented by drawing in two mutually perpendicular directions in the plane of the film to achieve a satisfactory combination of mechanical and physical properties.

Orientation and stretching apparatus to uniaxially or biaxially stretch film are known in the art and may be adapted by those skilled in the art to produce films of the present invention. Examples of such apparatus and processes include, for example, those disclosed in U.S. Pat. Nos. 3,278,663; 3,337,665; 3,456,044; 4,590,106; 4,760,116; 4,769,421; 4,797,235 and 4,886,634.

The process to obtain an oriented blown film is known in the art as a double bubble technique, and can be carried out as disclosed in U.S. Pat. No. 3,456,044. For example, a primary tube is melt extruded from an annular die. This extruded primary tube is cooled quickly to minimize crystallization. It is then heated to its orientation temperature (e.g., by means of a water bath). In the orientation zone of the film fabrication unit a secondary tube is formed by inflation, thereby the film is radially expanded in the transverse direction and pulled or stretched in the machine direction at a temperature such that expansion occurs in both directions, perhaps simultaneously; the expansion of the tubing being accompanied by a sharp, sudden reduction of thickness at the draw point. The tubular film is then again flattened through nip rolls. The film can be reinflated and passed through an annealing step (thermofixation), during which step it is heated once more to adjust the shrink properties. For preparation of food casings (e.g., sausage casings, shrink bags) it may be desirable to maintain the film in a tubular form. For preparing flat films the tubular film can be slit along its length and opened up into flat sheets that can be rolled and/or further processed.

A laminated film of the impermeable outer layer and the absorptive inner layer may be further laminated on the surface away from the absorptive layer to a shrink film if so desired. This may be accomplished by adhesive lamination processes known in the art using water-based, solvent or solventless adhesives. The shrink film may be laminated to the impermeable film layer of the barrier layer/absorptive layer film laminate before coating with an agent such as liquid smoke or after coating with liquid smoke, as is expedient. The shrink film may also be laminated in such a way that it protrudes from the film edge of the impermeable film/absorptive film laminate by a width of 10 to 50 mm in order to provide a sealing edge strip during the food-stuffing operation.

The invention also includes a tubular casing or shrinkbag or thermoformable pouch comprising a film that comprises or is produced from the film disclosed above in which the inner layer is an absorptive layer.

The above described film may be used in a form-fill-seal application. In this manner, the roll of film passes along, over, and around a forming shoulder to form a tube with overlapping edges. The formed tube then travels through a longitudinal sealing station wherein the overlapping edges are sealed, typically via a thermal process. There may be a short cooling and gathering station following sealing. Following this, the so-formed tube passes over the exterior of a stuffing horn. Concentric with the interior of the forming shoulder is a tube conveying a foodstuff, which connects to the stuffing horn. A short portion of the formed tube is drawn off the end of the stuffing horn and closed, typically with a metal clip. The filling operation commences wherein the foodstuff exits the stuffing horn, fills the formed tube, and draws additional film off the stuffing horn. At a predetermined interval, such as about 30 to about 72 inches, the filling operation pauses, about 1 to about 2 inches of formed tube is drawn off the end of the stuffing horn and collapsed, and closures (e.g., metal clips) are placed around the collapsed formed tube. The collapsed tube is severed between the adjoining closures, and the foodstuff filled log exits the operation, and the cycle of filling of the next log begins. This process is more fully described in U.S. Pat. No. 6,146,261.

The following Examples are merely illustrative and are not to be construed as to limit the scope of the invention.

### EXAMPLE 1

A multilayer film coated with an antimicrobial agent is prepared by the following procedure. A polyetherester copolymer, Polymer A, having a composition of 45 wt. % 1,4-butylene terephthalate and 55 wt. % ethylene oxide/propylene oxide copolyether terephthalate, and having a calculated ethylene oxide content of 33%, is formed into a seven-layer laminate that has the following layered structure, from inner absorptive layer (Polymer A) to outer layer (polypropylene): Polymer A/Bynel®21E787/nylon 6/EVOH/nylon 6/Bynel®50E725/polypropylene. The total gauge of the film laminate is 3 mils and the layer distribution, in volume percent is, from Polymer A to polypropylene, respectively, 25/7/10/16/10/7/25. The film laminate is formed by a blown film coextrusion process. The thus-prepared film laminate is coated with an aqueous solution of deionized water containing 35 wt. % ethanol and 10,000 IU/ml nisin. The coating process consists of introducing the aqueous solution into the trough of a container that is equipped with a moving 55 Quad gravure roll having a width of 40 inches which is in contact with the aqueous solution. The moving gravure roll is contacted with the laminated film moving at a line speed of 300 feet/minute and the moving gravure roll deposits a coating of the aqueous solution onto the film. The film is subsequently dried to produce a nisin-coated film that is folded, heat-sealed together to form a four-sided pouch, that is heat-sealed on three sides with an opening on the fourth side.

### EXAMPLES 2-6

Using the method of Example 1 a series of film laminates coated with antimicrobial and fungistatic agents is prepared. Laminate components, structures and coating process conditions are shown in Table I.

TABLE I

| | Inner | | | | Line |
|---|---|---|---|---|---|
| | Absorptive | Laminate | Antimicrobial or | Gravure | Speed |
| Example | Layer | Structure | Fungistatic Agent | Roll | (feet/min.) |
| 2 | Polymer B¹ | Laminate 1² | Chitosan Soln.³ | 35 Quad | 30 |
| 3 | Polymer A | Laminate 2⁴ | Benzoic Acid Soln.⁵ | 55 Quad | 100 |
| 4 | Polymer A | Laminate 3⁶ | Citric Acid Soln.⁷ | 44 Quad | 300 |
| 5 | Polymer B | Laminate 4⁸ | Benzoic Acid/Nisin Soln.⁹ | 35 Quad | 225 |
| 6 | Polymer B | Laminate 5¹⁰ | Nisin Soln.¹¹ | 44 Quad | 150 |

¹Polymer B-Polyetherester having copolymerized units of 42 wt. % 1,4-butylene terephthalate, 35 wt. % ethylene oxide/propylene oxide copolyether terephthalate, 10 wt. % ethylene oxide/propylene oxide copolyether isophthalate. Calculated ethylene oxide content 13%.
²Laminate 1- Polymer B/Bynel ® 21E787/Nylon 6/Bynel ® 4104/linear low density polyethylene, total gauge 2 mils, layer distribution 40/3/6/3/48 volume %.
³Chitosan Soln. - Aqueous deionized water solution containing 0.5 wt. % acetic acid and 1 wt. % chitosan (i.e. 2-amino-2-deoxy-β-D-glucopyranose).
⁴Laminate 2- Polymer A/Bynel ® 21E787/nylon 6/EVOH/nylon 6/Bynel ® 50E725/polypropylene homopolymer/Bynel ® 50E725/nylon 6, total gauge 6 mils, layer distribution 13/5/10/10/10/5/32/5/10 volume %.
⁵Benzoic Acid Soln. - Aqueous deionized water solution containing 0.75 wt. % benzoic acid and 35 wt % ethanol.
⁶Laminate 3- Polymer B/Bynel ® 21E787/EVOH/Bynel ® 50E725/polypropylene homopolymer, total gauge 2 mils, layer distribution 40/5/10/5/40 volume %.
⁷Citric Acid Soln. - Aqueous deionized water solution containing 7.5 wt. % citric acid.
⁸Laminate 4- Polymer A/Bynel ® 21E787/nylon 6/EVOH/nylon 6/Bynel ® 21E787/polyethylene terephthalate, total gauge 4 mils, layer distribution 20/5/10/10/10/5/40 volume %.
⁹Benzoic Acid/Nisin Soln. - Aqueous deionized water solution containing 2.9 wt. % benzoic acid, 7500 IU/ml nisin and 35 wt. % ethanol.
¹⁰Laminate 5- Polymer B/Bynel ® 21E787/EVOH/Bynel ® 21E787/Surlyn ® 1601/Bynel ® 21E787/polypropylene homopolymer, total gauge 4 mils, layer distribution 20/5/10/5/25/5/30 volume %.
¹¹Nisin Soln. - Aqueous deionized water solution containing 2500 IU/ml nisin and 35 wt. % ethanol.

1. A process for producing an antimicrobial or fungistatic film comprising the steps of introducing a fluid additive into a container equipped with a moving gravure roll; picking up the fluid additive from the container with the gravure roll; delivering the additive into or onto a flat film; drying the film; and optionally converting the flat film into a tubular film wherein
the process is carried out batch-wise or continuously;
the fluid additive comprises a flavorant, a colorant, or a combination of two or more thereof;
the film comprises a liquid absorptive inner layer and an outer impermeable barrier layer; and
the liquid absorptive inner layer comprises at least one antimicrobial or fungistatic agent.

2. The process of claim 1 wherein the absorptive inner layer comprises a polymer selected from the group consisting of block copolyetherester polymers, block copolyetheramide polymers, and combinations of two or more thereof; and the outer impermeable barrier layer comprises at least one layer selected from the group consisting of polyamides, copolyetheramides, block copolyetherester elastomers, ethylene vinyl alcohol copolymers, polyvinylidene chloride, polyolefins, or combinations of two or more thereof.

3. The process of claim 2 wherein the liquid absorptive inner layer comprises an antimicrobial agent selected from the group consisting of a) a combination of one or more bacterial polypetides and one or more hop extracts, b) a combination of a bactericidal compound and beta hops acid or beta hops acid derivative or both, c) a combination of natamycin, dialkyl dicarbonate and a sorbate preservative, d) a combination of calcium lactate and a sequestering agent, e) a heat-treated lactic acid, f) a heat-treated glycolic acid, g) an antibiotic, h) lysozyme, i) pediocin, j) lacticin, k) immobilized lactoferrin, l) chitosan, m) benzoic acid, n) propionic acid, o) sorbic acid, and p) combinations of two or more thereof of said agents.

4. The process of claim 3 wherein the antimicrobial agent additionally comprises a sequestering agent selected from the group consisting of citric acid, tartaric acid, maleic acid, oxalic acid, ascorbic acid, erythorbic acid, phosphoric acid, a salt thereof, and combinations of two or more thereof; and the antimicrobial agent is selected from the group consisting of lantibiotic, pediocin, lacticin class bacteriocin, lytic enzyme, and combinations of two or more thereof.

5. The process of claim 3 wherein the antimicrobial agent is selected from the group consisting of chitosan, benzoic acid, citric acid, and combinations of two or more thereof.

6. The process of claim 2 wherein the liquid absorptive inner layer comprises a block copolyetherester comprising polyether blocks and polyester blocks and the barrier layer comprises polyamide.

7. The process of claim 6 wherein the fluid additive is a flavorant.

8. The process of claim 7 wherein the fluid additive is an aqueous liquid optionally comprising solvent.

9. The process of claim 8 wherein the solvent is selected from the group consisting of ethanol, propanol, isopropanol, butanol, 1,3-propanediol, and combinations of two or more thereof.

10. The process of claim 3 wherein the outer impermeable barrier layer is a single film layer, a laminate, or a multilayer film and the flat film further comprises at least one tie layer.

11. The process of claim 9 wherein the outer impermeable barrier layer is a single film layer, a laminate, or a multilayer film and the flat film further comprises at least one tie layer.

12. The process of claim 10 wherein the inner liquid absorptive layer has a moisture vapor transmission rate of at least about 1200 g·25 μ/m²·24 hrs at 38° C., 100% humidity.

13. The process of claim 10 wherein the inner liquid absorptive layer is a copolyether ester comprising a long chain ester having copolymerized units of an ethylene oxide/propylene oxide copolyether glycol having a molecular weight of about 1800 to about 2500 and having a moisture vapor transmission rate of at least about 1200 to about 20000 g·25 μ/m²·24 hrs at 38° C., 100% humidity.

14. The process of claim 13 wherein the film is a blown film or a cast film.

15. The process of claim 14 wherein barrier layer is nylon, EVOH, or combinations thereof.

16. The process of claim 15 further comprising a layer that comprises polypropylene, polyethylene, or combinations thereof.

17. The process of claim 14 wherein the film is biaxially oriented.

18. The process of claim 15 wherein the film is laminated onto a biaxially oriented film, and the oriented film is optionally heat shrinkable and has a heat shrink of 5% to 50% in the machine direction and in the transverse direction at 85° C. to 95° C.
